(19) United States
(12) Patent Application Publication
(10) Pub. No.: US 2006/0195382 A1
(43) Pub. Date: Aug. 31, 2006

(54) Method for providing auction service via the internet and a system thereof

(76) Inventor: Do Heon Sung, Seoul (KR)

Correspondence Address: LADAS & PARRY LLP, 224 SOUTH MICHIGAN AVENUE, SUITE 1600, CHICAGO, IL, 60604, US

(21) Appl. No.: 10/553,913

(22) PCT Filed: Nov. 4, 2003
(86) PCT No.: PCT/KR03/02338

§ 371 Date: Oct. 20, 2005

(30) Foreign Application Priority Data
Apr. 24, 2003 (KR) 10-2003-0025987

(51) Int. Cl. G06Q 40/00

(52) U.S. Cl. 705/37

(57) ABSTRACT

Disclosed herein is a method and apparatus for providing an auction service via the Internet. The auction service providing method includes the step of maintaining a commodity information database (DB). Thereafter, a bid information DB is maintained. Bid request data including specific bid price information is received from bidders. The bid request data is recorded in bid registration fields of the bid table. Successful bidders are determined according to predetermined criteria. The predetermined criteria are based on the bid price information of the bid registration field and the number of items of the bid request data. The step of determining one or more successful bidders comprises the steps of calculating the number of items of the bid request data, and selecting bid registration fields having a smallest number of items of bid request data, and selecting a bid request field having a lowest bid price, and determining bidders having registered bid request data in the selected bid registration field to be successful bidders.

### FIELD OF THE INVENTION

The present invention relates generally to a method and system for providing an auction service via the internet and, more particularly, to a method and system for providing an auction service via the Internet, which determines a smallest group of lowest bidders to be successful bidders on a lowest price base.

### DESCRIPTION OF THE RELATED ART

With the rapid development of electronic commerce, a variety of on-line auction methods have made their appearances and are being utilized Most of on-line auction methods operate auction services based on a real auction method in which commodities for sale at auction are announced and the commodities are provided to a highest bidder.

The conventional on-line auction method simply realizes an off-line auction method in an on-line manner. Accordingly, the conventional on-line auction method has all the problems of the off-line auction method except that accessibility is provided to bidders so that the bidders can be supplied with auction services without temporal and spatial restriction in an Internet-accessible environment.

That is, the highest price-based on-line auction method is problematic in that, when excessively strong competition occurs, the price of a successful bid is formed above a normal market price. Furthermore, since a highest bidder is always provided with the high probability of a successful bid, equal opportunities cannot be provided to all bidders.

Even if a successful bid is achieved through strong competition, the intention for actually purchasing a commodity fully depends on a successful bidder. Accordingly, even when the successful bidder does not purchase the commodity, no sanction is applied to the successful bidder and bidders who actually desire to purchase the commodity may take harm.

To overcome the above-described problems, a reverse auction method is utilized as a modified auction method. The reverse auction method is the auction method in which a plurality of sellers offer the prices of a commodity to a buyer having made a purchase request for the commodity and the buyer selects one among these offers.

However, the reverse auction method is problematic in that a service is unreliable due to excessive competition and low quality commodities are supplied to successful bidders due to low prices.

Accordingly, the advent of a new auction method and system capable of overcoming the problems of the conventional auction and reverse auction methods has been eagerly demanded. Furthermore, there is demanded a lowest price-based auction method in which the attention of bidders to and the participation of bidders in an auction service can be promoted by introducing a game element for providing opportunities to lowest bidders.

### SUMMARY OF THE INVENTION

Accordingly, the present invention has been made keeping in mind the above problems occurring in the prior art, and an object of the present invention is to provide an auction providing method and system, which determines successful bidders using a lowest bid price-based successful bid determination method of determining a smallest group of lowest bidders to be successful bidders, thus providing high-quality commodities to bidders at reasonable prices.

Another object of the present invention is to provide an auction providing method and system, which determines one or more lowest bidders to be successful bidders rather than a single highest bidder to be a successful bidder, thus preventing auctions from being unsuccessful and providing more opportunities for successful bids to bidders.

Still another object of the present invention is to provide an auction providing method and system, which grants bid numbers to bidders according to the time when the bidders participate in an auction and calculates the priorities of bidders having offered the same bid price based on the sequence of the bid numbers, thus reducing the influence of the sequence of participation on the determination of successful bidders and promoting the interests of bidders at the early stage of the auction.

In order to accomplish the above object, the present invention provides a method of providing an auction service via the Internet, comprising the steps of maintaining a commodity information database (DB) for storing commodity information of a commodity for sale at auction; maintaining a bid information DB for storing a bid table for registering bid request data regarding the commodity for sale at auction; receiving bid request data including specific bid price information from bidders having searched the commodity information of the commodity or sale at auction; registering the bid request data in bid registration fields of the bid table corresponding to the bid price information; and determining one or more successful bidders according to predetermined criteria by analyzing the bid request data having been registered in the bid table after an elapse of a predetermined period; wherein the predetermined criteria are based on the bid price information of the bid registration field and the number of items of the bid request data; wherein the step of determining one or more successful bidders comprises the steps of calculating the number of items of the bid request data having been registered in the each of the bid registration fields, and selecting one or more bid registration fields having a smallest number of items of bid request data, and selecting a bid request field having a lowest bid price among the selected bid registration fields, and determining one or more bidders having registered bid request data in the selected bid registration field to be successful bidders.

In addition, the present invention provides a system for providing an auction service via the Internet, comprising a commodity DB for storing commodity information of a commodity for sale at auction; a bid information DB for storing a bid table for registering bid request data regarding the commodity for sale at auction; interface means for receiving bid request data including specific bid price information from bidders having searched the commodity information of the commodity for sale at auction; bid registration means for registering the bid request data in bid registration fields of the bid table corresponding to the bid price information; and a successful bid control means for determining one or more successful bidders according to predetermined criteria by analyzing the bid request data registered in the bid table after an elapse of a predetermined period; wherein the predetermined criteria are based on the bid price information of the bid registration field and numbers of items of the bid request data; wherein the successful bid control means selects one or more bid registration fields having a smallest number of items of bid request data, selects a bid request field having a lowest bid price among the selected bid registration fields, and determines one or more bidders having registered bid request data in the selected bid registration field to be successful bidders.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing the system for providing an auction service according to a preferred embodiment of the present invention;

FIGS. 2a and 2b are views showing examples of a bid table according to the present invention;

FIG. 3 is a flowchart showing a method of providing an auction service according to a preferred embodiment of the present invention;

FIG. 4a is a view showing the commodity information of the commodity for sale at auction, which is registered in the commodity information DB;

FIG. 4b is a view showing an example of the creation of bid request data;

FIG. 4c is a view showing an example of created bid request data;

FIG. 5a is a flowchart showing a method of determining successful bidders according to the embodiment of the present invention;

FIG. 5b is a flowchart showing an example of a method of determining a successful bidder;

FIG. 6 is a flowchart showing an example of a method of allowing the successful bidder to purchase the commodity for sale at auction;

FIG. 7 is a flowchart showing a method of handling the case where a confirmation response is not created by the successful bidder within a predetermined period;

FIG. 8 is a flowchart showing an example of a method of processing the payment of bid fees according to a preferred embodiment of the present invention; and

FIG. 9 is a block diagram showing the internal configuration of a general-purpose computer applicable to the auction service providing method and system of the present invention.

### DESCRIPTION OF THE PREFERRED EMBODIMENTS

Reference now should be made to the drawings, in which the same reference numerals are used throughout the different drawings to designate the same or similar components.

A method and system for providing an auction service via the Internet according to the present invention is described in detail with reference to the accompanying drawings.

In the present specification and claims, the term “bidder” refers to an Internet user searching the commodity information of a commodity for sale at auction using a certain terminal, who can creates bid request data after searching the commodity information. The term “bid request data” refers to information data that a bidder having the intention for participating in an auction creates to notify the auction service providing system of the participation of the bidder in the auction.

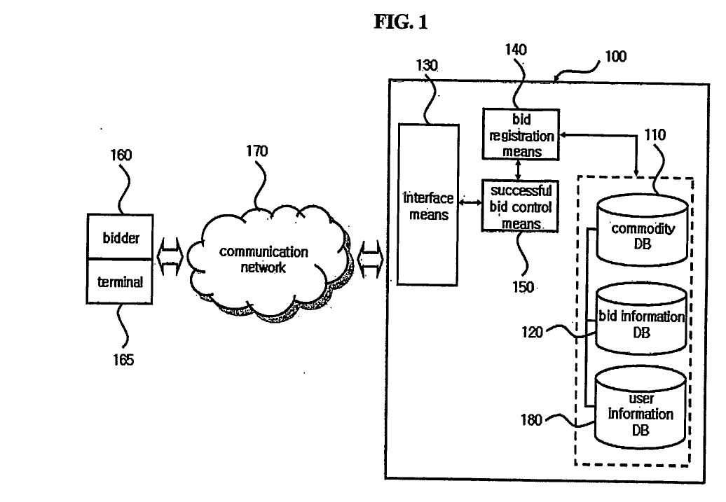

FIG. 1 is a configuration diagram showing the system for providing an auction service according to an embodiment of the present invention.

As shown in FIG. 1, the auction service providing system 100 includes a commodity DB 110, a bid information DB 120, an interface means 130, a bid registration means 140, and a successful bid control means 150.

The commodity information DB 110 is a DB for storing the detailed information of commodities being auctioned or to be auctioned. For example, in the commodity information DB 110, commodities are classified into various categories and the information of a commodity is stored in a storage area assigned to a category corresponding to the commodity. The commodity information is recorded and/or registered by providers desiring to auction commodities or a system operator, and includes provider information, commodity information, commodity names, commodity photos, and commodity specifications. In particular, the commodity information may include bid price range information that indicates the range of bid prices that bidders 160 can offer at the time of bids. The bid price range information functions to prevent the excessive increase of a bid price due to excessive competition between bidders, and to attract the interests of bidders through the introduction of a game component for allowing bid prices to be offered within the range of predetermined bid prices. Additionally, the bid price range information affects the number of bid registration fields included in a bid table described later, so that the bid table has one or more bid registration fields corresponding to certain bid prices between an upper limit and a lower limit. The classification and detailed descriptions of the bid registration fields will be described below.

The bid information DB 120 is a DB for storing the bid table in which bid request data created by the bidders 160 are registered. The bid table stored in a certain assigned area of the bid request DB 120 may be created in conjunction with the registration of a commodity in the commodity information DB 110.

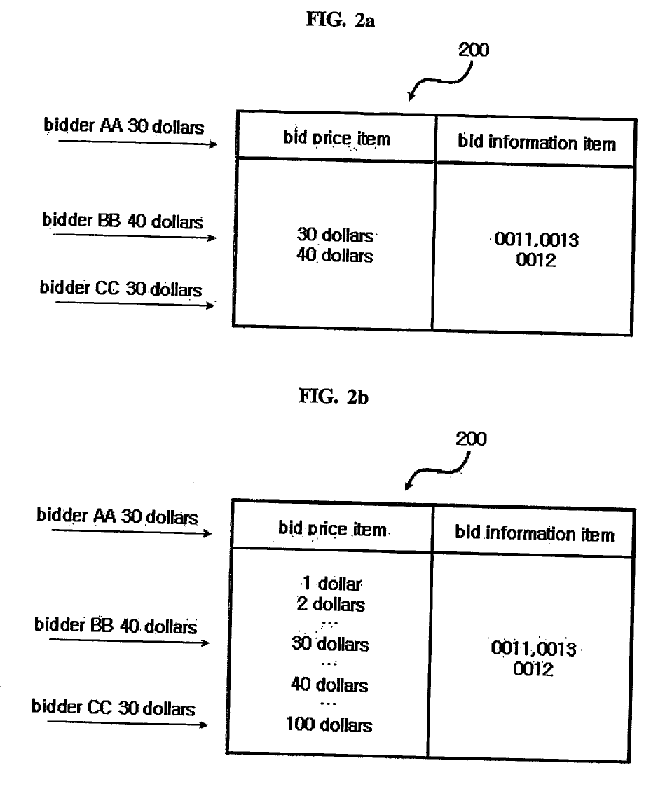

The bid table is described in detail with reference to FIGS. 2a and 2b below. FIGS. 2a and 2b are views showing examples of a bid table 200 according to the present invention. As shown in FIGS. 2a and 2b, the bid table 200 stored in the bid information DB 120 includes one or more bid registration fields distinguished from each other by bid prices. Each of the bid registration fields includes a bid price item for indicating a bid price and a bid information item for registering bid information associated with the input of bid request data.

With respect to the creation of the bid registration field, two creation methods can be taken into consideration in the present embodiment. That is, there are a method of creating a bid registration field as well as registering a new bid price item in response to the input of a bid price, and a method of creating bid registration fields with respect to bid prices based on the bid price range information of commodity information stored in the commodity information DB 110 and storing the created bid registration fields.

In the method of creating the bid registration field in response to the input of the bid request data, the bid price item corresponding to the bid price of the bid request data is constructed, and the bid registration field including the constructed bid price item is created. For example, in the case where the bid price of the bid request data input by a bidder AA is 30 dollars and the bid price of the bid request data input by a bidder BB is 40 dollars, two bid registration fields with 30 dollars and 40 dollars entered in bid price items are created in a corresponding bid table 200 of the bid information DB 120, as shown in FIG. 2a.

In contrast, in the method of previously creating the bid registration fields based on the bid price range information, a certain number of bid registration fields are created with the upper limit and lower limit of the bid price range information taken into consideration. For example, in the case where the bid price range information indicates a range of 1 dollar to 100 dollars, 100 bid registration fields having 100 bid price items corresponding to 1 dollar to 100 dollars, respectively, are created in a corresponding bid table 200 of the bid information DB 120, as shown in FIG. 2b. When the bid price information described above is input, bid registration fields corresponding to 30 dollars and 40 dollars are extracted from the bid table 200 and bid request data are registered in corresponding bid information items.

As a result, it is preferable that the method of creating the bid registration fields is flexibly selected in view of the amount of bid request data.

The bid information item is an information item for indicating each of the bidders 160 who participates in an auction while offering a specific bid price, and allows multiple items of bid request data including the same bid price to be distinctively registered. In accordance with an embodiment of the present invention, the concentration of bids on a specific bid price can be prevented by limiting the number of items of bid request data, which will be registered in the bid information item, to a specific number. In the present embodiment, the number of items of bid request data to be registered in the bid information item corresponds to the number of bidders 160, and a tendency for the bidders 160 to participate in the auction while offering the lowest price can be suppressed by limiting the number of bidders 160 who can participate in the auction while offering a specific bid price, to a specific number. Furthermore, the limitation of the number of items of bid request data provides a larger opportunity of making a successful bid to later participating bidders 160 by suppressing bids of bid prices having a low possibility of making a successful bid.

The bid request data registered in the bid information item is preferably bid number information, and the bid number information may be created based on the information of the time when each of the bidders 160 inputs bid request data to the auction service providing system 100 of the present invention. That is, when each of the bidders 160 notifies the auction service providing system 100 of his or her participation in the auction (for example, by clinking a “bid” button), bid number information may be created based on the time when the auction service providing system 100 is notified of the participation in the auction. As a result, the bid number information can include information about a position in the sequence of bids. The created bid number information can update some of bid details in the storage area assigned to a corresponding bidder 160 in a user information DB 180, and may be extracted in response to the request of the bidder 160 and displayed on a corresponding one of terminals 165. The bid number information including the information about the time of participation in an auction is involved to determine priority between bidders offering the same bid price. The determination of the priority will be described later.

An example is described below to allow the description of the bid table to be totally and clearly understood.

As shown in FIGS. 2a and 2b, the case where bidder AA, bidder BB and bidder CC bid 30 dollars, 40 dollars and 30 dollars for a specific commodity for sale at auction is considered. Furthermore, it is assumed that the bidder AA has the earliest input time of bid request data and the bidder CC has the latest input time of bid request data. For example, if items of bid number information assigned to the bidders AA, BB and CC are ‘0011’, ‘0012’ and ‘0013,’ respectively, bid registration fields corresponding to 30 dollars and 40 dollars are created and extracted in and from the bid table of the commodity, and the items of input number information are registered in the bid information items of the created and extracted bid registration fields, as shown in FIGS. 2a and 2b. That is, ‘0011’ and ‘0013’ are registered in a bid information item corresponding to a bid price of 30 dollars, while ‘0012’ is registered in a bid information item corresponding to a bid price of 40 dollars.

Furthermore, the magnitudes of bid prices of the bid price items are formed within a range of an upper limit to a lower limit based on the bid price range information of the commodity information, so that optimal bid registration fields are formed within a predetermined range, thus preventing the storage areas of the bid information DB 120 from being wasted.

In the bid table, bid registration fields corresponding to the bid price information of the bid request data are extracted, the bid request data are registered in the extracted bid registration fields, and the bid registration fields in which the bid request data have been registered are sorted. Accordingly, when one of the bidders 160 requests the present bid status of a specific commodity, only the bid registration fields in which the bid request data have been registered can be provided to the bidder 160, thus maximally facilitating the acquisition of bid information associated with the auction of the commodity.

The interface means 130 functions to transmit and receive various items of information associated with an Internet-based auction service to and from the bidders 160 located outside the auction service providing system 100, and is connected to the terminals 165 held by the bidders 160 via a communication network 170 such as the Internet. The interface means 130 performs protocol conversion so that various items of information (for example, bid request data, and information on a right to preferential purchase) transmitted via the communication network 170 can be transmitted without distortion or impairment according to optimal protocols. In this case, the terminals 165 have processor means and communication modules and, thus, can perform computations and communications. The terminals 165 may be exemplified by personal computers, notebooks, mobile phones, smart phones or Personal Digital Assistants (PDA).

The bid registration means 140 is a means for registering bid request data received from the bidders 160 in the bid table, and registers the bid number information assigned to the bidders 160 in the bid information items of the bid registration fields corresponding to the bid price information. Although, in the present embodiment, information registered in the bid information item has been described as being the bid number information as an example, this has been taken for ease of description. Accordingly, it is apparent that various types of information, such as the user identifiers of the bidders 160 and contact information (phone numbers), that can be used to announce the participation of the bidders 160 in the auction may be included in the bid information items.

The successful bid control means 150 is a means for determining a successful bidder according to certain criteria by analyzing one or more items of bid request data registered in the bid table, and functions to select a specific bid registration field including a successful bidder according the registration status of bid request data registered in the bid table after a predetermined period, that is, after the period for which bidders 160 can participate in the auction elapses. In the present embodiment the magnitude of the bid price of a specific bid registration field or the number of items of bid request data registered in the specific bid registration field may be used as the criteria for the selection of the specific bid registration field by the successful bid control means 150. That is, the successful bid control means 150 primarily selects one or more bid registration fields each having a smallest number of items of registered bid registration data (selection of bid registration fields having the smallest number of bidders), and secondarily selects a bid registration field having the lowest bid price among the primarily selected bid registration fields as the bid registration field including the successful bidder (selection of a bid registration field having the lowest bid price). All bidders having registered bid request data in the bid registration field secondarily selected by the successful bid control means 150 are determined to be successful bidders. Preferably, a bid registration field in which one of the bidders 160 have registered bid request data is selected, and the bidder is determined to be a successful bidder.

In accordance with another embodiment of the present invention, when two or more bidders 160 have registered two items of bid request data in the secondarily selected bid registration field, the successful bid control means 150 assigns priorities to the items of bid request data, preferably, multiple items of bid number information, and one of the bidders 160 having registered bid number information having the highest priority is determined to be the successful bidder. The assignment of priorities to multiple items of bid number may be performed in such a way as to assign priorities in descending order according to the information of time when the bidders 160 input the items of bid request data. In this case, larger opportunities are provided to bidders having participated in the auction earlier than other bidders. The assignment of priorities according to the time information is designed to overcome an operational defect in which larger opportunities are provided to bidders 160 having participated in the auction later than other bidders 160 while recognizing preoccupied bid registration fields in which bid request data are registered by some bidders 160, and offering bid prices capable of avoiding the preoccupied bid registration fields. Accordingly, the successful control means 150 can eliminate arguments over opportunities for successful bids by reducing the influence of the sequence of participation on the determination of successful bidders. As a result, the present embodiment is advantageous in that the participation and interests of bidders 160 can be promoted at the early stage of the auction.

The auction service proving system 100 of the present invention may further include the user information DB 180 for storing the basic personal information of the bidders 160. In this case, an authentication control means (not shown) authenticates bidders 160 transmitting bid request data using the basic personal information. The basic personal information is requested when the bidders 160 first apply for membership, and may include user identifiers, passwords, the contact information of the bidders 160 or the bid detail information of the bidders 160.

Although not shown in FIG. 1, an auction service providing system 100 according to a preferred embodiment of the present invention may further include a DB management module (not shown) for managing the above-described DBs 110, 120 and 180. The DB management module of the present embodiment may be implemented to fit the objects of the present invention using Relational DB Management Systems (DBMSs), such as Oracle, Infomix, Sybase or DB2, or Object-Oriented DB Management Systems (OODBMS), such as Gemston, Orion or O2.

The operation of the auction service providing system of the present invention constructed as described above is described in detail below.

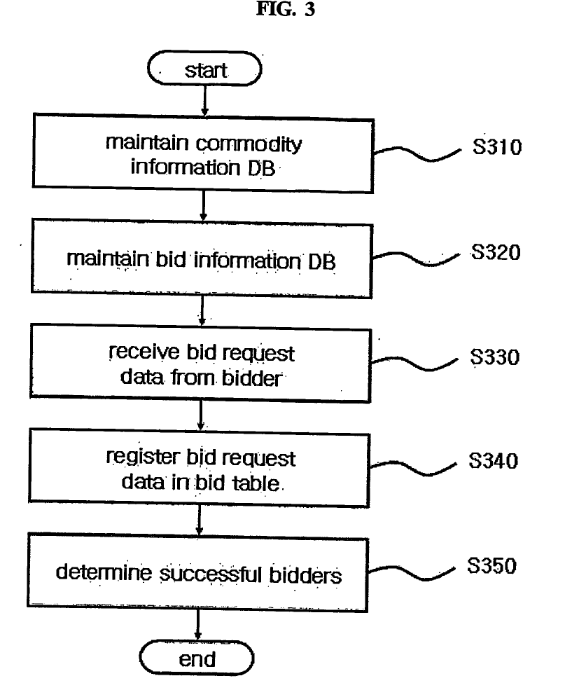

FIG. 3 is a flowchart showing a method of providing an auction service according to a preferred embodiment of the present invention.

The service providing method of the present invention is performed by the auction service providing systems described above.

The auction service providing system 100 maintains the commodity information DB 110 for storing the information of commodities for sale at auction at step S310. Step S310 is the step of registering and storing the information of commodities for sale at on-line auction using the Internet in the commodity information DB 110. At this step, commodities for sale at auction not only are registered and stored in the commodity information DB 110 but also the information of commodities for sale at auction is recorded in the commodity information DB 110, so that the bidders 160 can be provided with the detailed information of commodities for sale at auction.

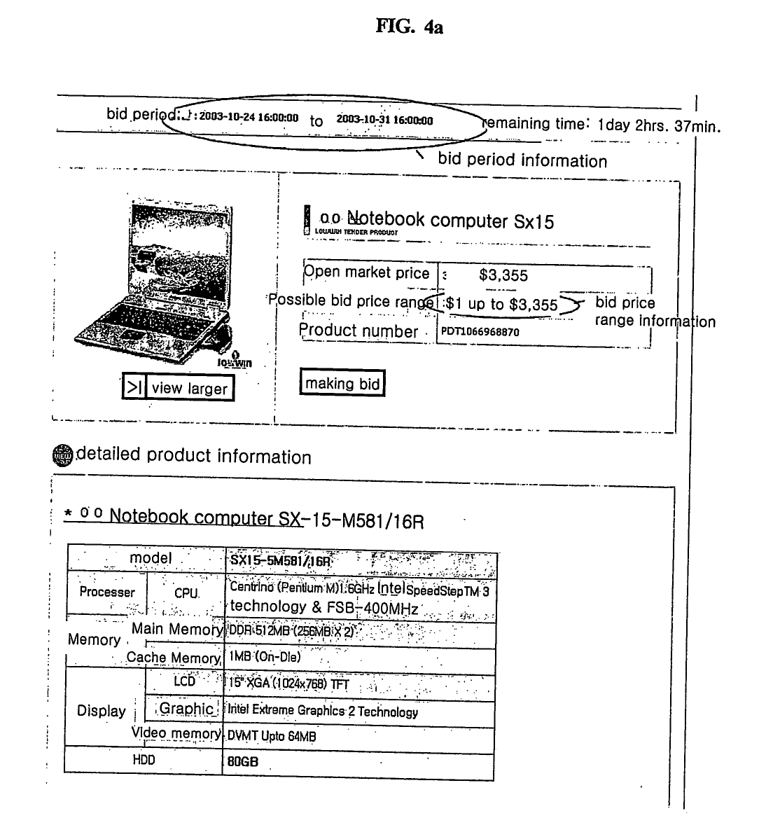

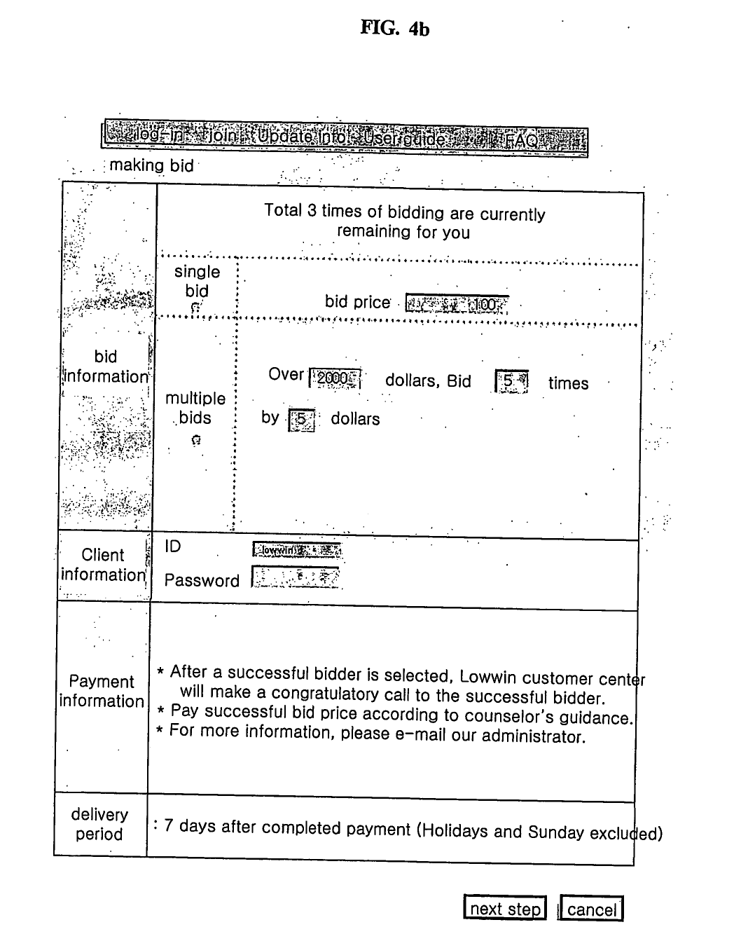

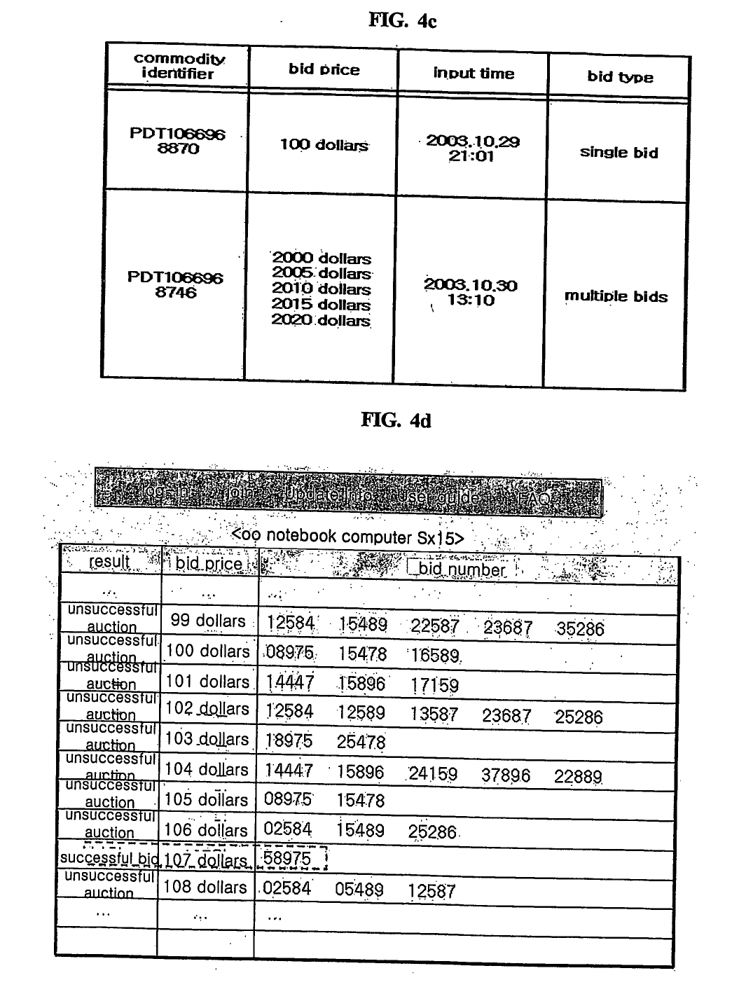

Referring to FIG. 4a, the information of a commodity for sale at auction is described in detail below. FIG. 4a is a view showing the information of the commodity for sale at auction, which is registered in the commodity information DB.

As shown in FIG. 4a, the commodity information may include provider information, the name of the commodity for sale at auction, a detailed photo and the specification of the commodity for sale at auction, and may be implemented so that the participation of bidders 160 in an auction can be correctly learned in such a way that the bidders 160 searching the commodity information can obtain detailed information about the commodity for sale at auction. In particular, the commodity information includes bid price range information indicating the range of bid prices that the bidders 160 can offer, and bid period information indicating an available bid period for the commodity for sale at auction, besides detailed information about the commodity for sale at auction. Accordingly, there can be prevented problems in which the interests of the bidders 160 are reduced due to an excessive increase in a bid price or the excessive extension of an available bid period. For example, FIG. 4a shows the case where the bid price range information indicates the range of bid prices from 1 dollar to 3,355 dollars and the bid period information indicates a bid period of a week. Accordingly, when bidders 160 make bids within the available bid period, the auction service providing system 100 determines whether to accept the participation of the bidders by examining bid prices offered by the bidders 160.

In the meantime, the auction service providing system 100 maintains the bid information DB 120 for storing the bid table in which bid request data for a commodity for sale at auction are registered at step S320. Step S320 is the step of storing the bid table for storing bid status in the bid information DB 120. At this step, the bid table created in conjunction with the registration and storage of a commodity for sale at auction in the commodity information DB 110 is maintained in a certain assigned area of the bid information DB 120 while being associated with the commodity for sale at auction. As described above, the bid table includes one or more bid registration fields distinguished from each other by bid prices, and allows bid request data input by the bidders 160 to be registered therein.

Thereafter, the auction service providing system 100 receives bid request data including bid price information from the bidders having searched commodity information at step S330. Step S330 is the step of receiving bid request data created by the bidders 160 having searched the commodity for sale at auction using the terminals 165 that maintain connection with the auction service providing system 100. The terminals 165 may include user interfaces for searching for a commodity for sale at auction and creating bid request data.

Referring to FIGS. 4b and 4c, bid request data created by the bidders 160 is described in detail below. FIG. 4b is a view showing an example of the creation of bid request data. FIG. 4c is a view showing an example of created bid request data.

When a bidder 160 clicks on a ‘bid’ button on a screen for providing the information of a commodity for which the bidder 160 desires to make a bid, the auction service providing system 100 controls a user interface to rum on the terminal 165 of the bidder 160, as shown in FIG. 4b. The user interface of FIG. 4a is used to determine bid prices that the bidder 160 will offer for the commodity for sale at auction. If the bidder 160 desires to make a single bid for the commodity (single bid of FIG. 4b), the creation of bid request data can be completed by inputting a bid price. In contrast, if the bidder 160 desires to make multiple bids for the commodity to increase the probability of a successful bid (multiple bids of FIG. 4b), the creation of bid request data can be completed by inputting an increment and the number of bids after inputting a reference bid price.

Accordingly, the bid request data created by the bidder 160, as shown in FIG. 4c, may include commodities for sale at auction identified by commodity identifiers, bid prices input as shown in FIG. 4b, and the input time information of bid request data. For example, when the bidder 160 make a single bid of 100 dollar for “00 notebook computer” of FIG. 4a (refer to FIG. 4b), a bid price of 100 dollars and input time information indicating ‘2003.10.29 21:01’ when the bid request data was input are recorded in the bid request data. Furthermore, the input time information is involved to create bid number information, and may be used as information for determining a priority between two or more bidders having offered the same bid price. When a bidder 160, as shown in FIG. 4b, inputs a reference bid price, an increment and the number of bids in the case where the bidder 160 desires to make multiple bids for ‘XX car,’ the bid price information created in the form of bid request data indicates ‘2000 dollars, 2005 dollars, 2020 dollars (refer to FIG. 4c).

Subsequently, the auction service providing system 100 registers received bid request data in the a bid table corresponding to the commodity for sale at auction at step S340. Step S340 is the step of learning bid price information included in the bid request data, and recording the bid request data in a bid registration field corresponding to the learned bid price information.

Referring to FIG. 4d, the bid request data recorded in the bid table is described in more detail below. FIG. 4d is a view showing an example of the bid table in which the bid request data is recorded.

As shown in FIG. 4d, the bid table stored in the bid information DB 120 includes one or more bid registration fields divided according to bid prices based on the bid price range information. A bid registration field corresponding to a bid price input by the bidder 160 is identified using, for example, a bid registration means 140. For example, when bid request data is created based on a single bid, as shown in FIG. 4c, the bid registration means 140 searches the bid information DB 120 for a bid table corresponding to commodity identifier ‘PDT1066968870,’ and identifies a bid registration field corresponding to bid price ‘100 dollars’. A bid registration number assigned to a bidder at the time of the input of a bid request data, for example, bid number ‘16589’ assigned to bidder ‘lowwin’ having made a bid for commodity ‘00 notebook computer Sx15,’ is registered in the bid information item of the identified bid registration field. Meanwhile, when other bidders 160 having offered the same price as the bidder ‘lowwin’ exist, bid numbers (for example, ‘08975’ and ‘15478’) assigned to the other bidders 160 may be stored in the bid information item of the identified bid registration field in which the bid number ‘16589’ has been registered.

Although, in the present embodiment; the bid request data registered in the bid information item is defined by the bid number information and described based on this definition, these definition and description are designed to determine priority between a plurality of bidders 160 when the plurality of bidders 160 make bids, which is made for ease of description Accordingly, in a method of not limiting the number of successful bidders, information, such as a user identifier capable of identifying a bidder 160, other than the bid number may be used for the bid request data.

Thereafter, after a predetermined bid period has elapsed, the auction service providing system 100 determines one or more successful bidders by analyzing one or more items of bid request data registered in the bid table at step S350. Step S350 is the step of selecting a bid registration field having the lowest bid price among bid registration fields, in which the smallest number of items of bid number information have been registered, after the bid period included in the commodity information has elapsed. Consequently, the bidders 160 having made bids of the lowest bid price are determined to be successful bidders, so that the present embodiment can fulfill the object of providing a lowest price auction service.

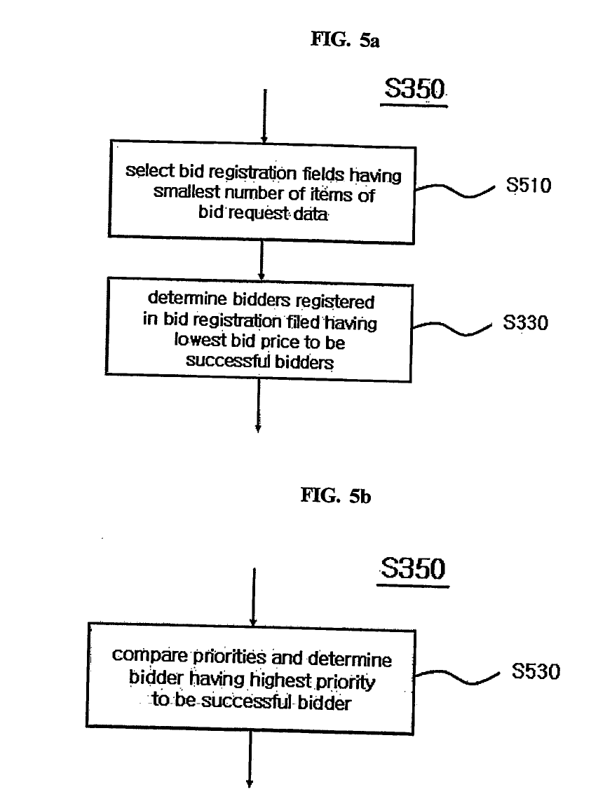

A method of determining successful bidders according to an embodiment of the present invention is described with reference to FIG. 5a below. FIG. 5a is a flowchart showing the method of determining successful bidders according to the embodiment of the present invention.

The auction service providing system 100 calculates the number of items of bid request data having been registered in each bid registration field, and select one or more bid registration fields having the smallest number of items of bid request data at step S510. Step S510 is the step of calculating the number of items of bid request data, preferably, bid number information, having been registered in each bid registration field, and select one or more bid registration fields having the smallest number of items of bid request data, preferably, bid number information. In a preferred embodiment of the present invention, a bid registration field having a single item of bid number information is selected.

Thereafter, the auction service providing system 100 selects a bid registration field having the lowest bid price from the bid registration fields selected at step S510, and determines the bidders 160 having registered the bid request data in the selected bid registration field to be successful bidders at step S520. Step S520 is the step of selecting a single bid registration field having the lowest bid price among the bid registration fields in which the smallest number of items of bid number information have been registered and, thereafter, determining the bidders 160 having registered bid number information in the selected bid registration field to be successful bidders. Accordingly, in the case where two or more items of bid number information have been registered in the selected bid registration field, the bidders of all the registered bid number information may be determined to be successful bidders. That is, even when the smallest number of items of bid number information having been registered in the bid registration field is two or more, all the relevant bidders are determined to be successful bidders, so that an auction for the commodity is prevented from being unsuccessful and more opportunities for making successful bids are provided to the bidders 160.

For example, in FIG. 4d, a bid registration field corresponding to bid price ‘107 dollars’ is selected as a bid registration field in which the smallest number of bid numbers have been registered and which has the lowest bid price, and a bidder having registered bid number ‘58975’ in the selected bid registration field is determined to be a successful bidder. Meanwhile, if the bid registration field corresponding to the bid price ‘017 dollars’ is excluded, two bidders having registered bid numbers in a bid registration field corresponding to bid price ‘103 dollars’ may be determined to be successful bidders.

As a result, the present invention can provide high quality products at low prices by providing an auction service in a low price-oriented auction manner. Furthermore, one or more bidders who have offered a smallest bid price and whose number is smallest are determined to be successful bidders, so that an auction for the commodity is prevented from being unsuccessful and more opportunities for making successful bids are provided to the bidders 160.

A method of comparing the priorities of bidders having offered the small bid price with each other and determining a single bidder having a highest priority to be a successful bidder in accordance with another embodiment of the present invention is descried with reference to FIG. 5b below. FIG. 5b is a flowchart showing an example of the method of determining a successful bidder.

In the present embodiment, when the number of selected successful bidders is two or more, the auction service providing server 100 compares the priorities of the bid number information of the successful bidders and determines a single bidder having the highest priority to be a final successful bibber at step S530. That is, the auction service providing server 100 selects a smallest group of the lowest bidders, and grants priorities to the bidders 160 by comparing the bid request data of the group, preferably, input number information including input time information Accordingly, more opportunities are provided to bidders having participated in the auction at the early stage of the auction, so that the interests and participation of the bidders in the auction can be maintained throughout the auction.

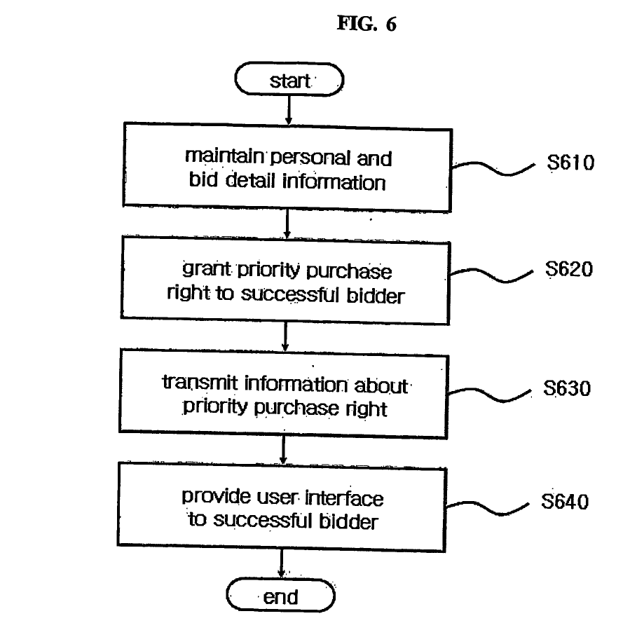

A method of allowing a bidder, who is determined to be a successful bidder, to purchase a corresponding commodity for sale at auction in the auction service providing method of the present invention is described in detail with reference to FIG. 6 below. FIG. 6 is a flowchart showing an example of the method of allowing the successful bidder to purchase the commodity for sale at auction.

The auction service providing system 100 of the present invention maintains the user information DB 180 that stores one or more of the user identifier, password, contact information and bid detail information of a bidder 160 at step S610. Step S610 is the step of storing and maintaining the basic personal information and bid history information of the bidder 160. Information associated with each bidder is stored in a storage area assigned to the bidder 160. In particular, the user information DB 180 may update bid history information while storing one or more items of bid request data created when the bidder 160 makes a bid for a commodity for sale at auction. For example, whenever the user information DB 180 receives bid request data, the user information DB 180 may updates the bid history information. When the bidder 160 requests the bid history information, the bid history information allows the bidder 160 to easily learn the status of bids by providing the bid details of the auction, in which the bidder 160 participates, to the terminal 165 of the bidder 160.

Thereafter, the auction service providing system 100 grants a priority purchase right for a commodity for sale at auction to a selected successful bidder, and records information about the granted priority purchase right in the user information DB 180 at step S620. Step S620 is the step of granting the successful bidder, who is determined on a lowest price base, an opportunity for purchasing a commodity for sale at auction before other bidders 160. For example, the priority purchase right may be granted to a bidder having the highest priority. In the method of selecting bidders on a fewest bidders/lowest price base without comparing priorities, priority purchase rights may be provided to all the bidders 160 having been registered in the selected bid registration field. Accordingly, the method of granting priority purchase rights may vary with the various embodiments of the present invention. In the present embodiment, for ease of description, the method of determining a single bidder having the highest priority to be a successful bidder is described as an example.

Subsequently, the auction service providing system 100 transmits the information of the priority purchase right granted to the selected successful bidder using the contact information of the successful bidder with reference to the user information DB 180 at step S630. In this case, the contact information is information capable of being used to notify the bidder, who is determined to be the successful bidder, of the determination of the successful bidder, and may be the wired/wireless phone number, e-mail address or residential address of the successful bidder. To transmit the priority purchase right information, a scheme of transmitting the priority purchase right information in the form of character information including a certain call-back relay may be considered. Furthermore, a confirmation response to the transmission of the priority purchase right information may be automatically transmitted to the auction service providing system 100 by the successful bidder confirming the character information.

The auction service providing system 100 provides a user interface for receiving purchase form data for the commodity for sale at auction to the successful bidder having made the confirmation response to the transmission of the priority purchase right information at step S640. Step S640 is the step of receiving a purchase request from the successful bidder having the intention of actually purchasing the commodity for sale at auction. For example, in the case where the priority purchase right information is transmitted to the terminal 165 of the successful bidder in the form of a short message including a cal-back Uniform Resource Locator (URL), a confirmation response to the short message is automatically transmitted to the auction service providing system 100 by clicking on the short message. The user interface provided to the terminal 165 of the successful bidder creates purchase form data in response to the selective input of the successful bidder. Such purchase form data may include information about a payment method and a delivery address (refer to FIG. 4b).

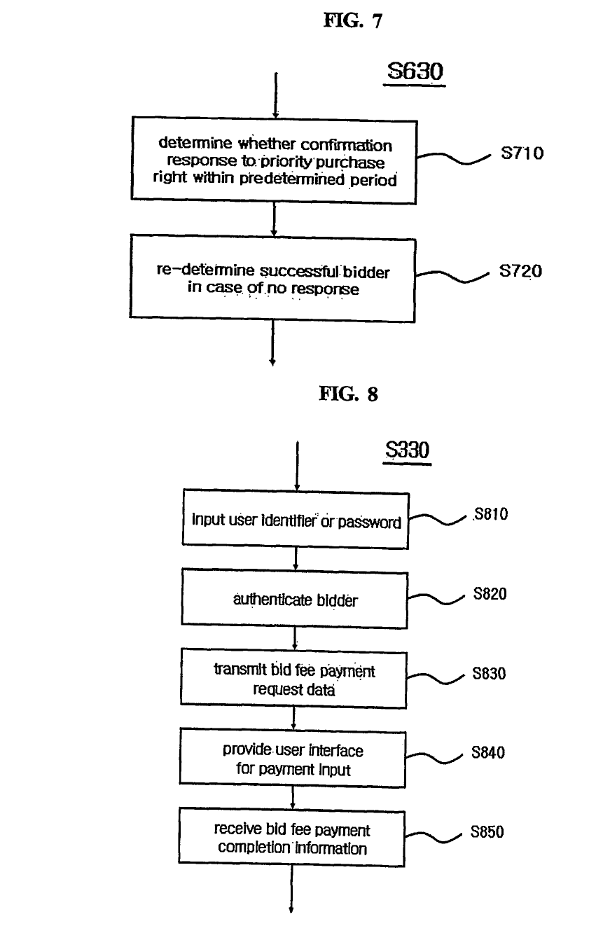

A method of handling the case where a confirmation response is not transmitted within a predetermined period is described with reference to FIG. 7 below. FIG. 7 is a flowchart showing the method of handling the case where a confirmation response is not created by the successful bidder within a predetermined period.

The auction service providing system 100 determines whether a confirmation response to priority purchase right information has been created by the successful bidder within a predetermined period at step S710. Step S710 is the step of confirming whether the successful bidder has the intention of actually purchasing the commodity for sale at auction. If the confirmation response to the priority purchase right information has not been transmitted from the successful bidder to the auction service providing system 100 within the available period of a priority purchase right, the auction service providing system 100 withdraws the priority purchase right granted to the successful bidder and records information about the withdrawal of the priority purchase right in the user information DB 180. The information about the withdrawal of the priority purchase right may be created by receiving a signal indicating the abandonment of the priority purchase right (for example, the signal is created by clicking on a priority purchase right abandonment button included in the above short message), or may be automatically created when the confirmation response has not been created by the successful bidder within a predetermined period after the transmission of the priority purchase right information.

Thereafter, the auction service providing system 100 re-determines a successful bidder according to certain criteria by analyzing bid request data having been registered in the bid table except the bid request data of the previous successful bidder at step S720. Step S720 is the step of excluding bid request data offered by the previous successful bidder and re-determining a successful bidder after confirming that the previous successful bidder has no intention of purchasing the commodity for sale at auction (refer to step S350). In the re-determination of the successful bidder, the successful bidder may be determined on the fewest bidders/lowest bid price base in the same way as described above. In the method of determining the successful bidder on a priority base, the bidder 160 having a next highest priority may be determined to be a successful bidder and is granted a priority purchase right. Information about the grant of the priority purchase right may be notified to the bidder 160.

Accordingly, the auction is prevented from being unsuccessful, so that bidders have the reliability of the auction. Furthermore, since the intention of purchasing the commodity for sale at auction is confirmed using a priority purchase right, successful bidders having made bids in error can be filtered out.

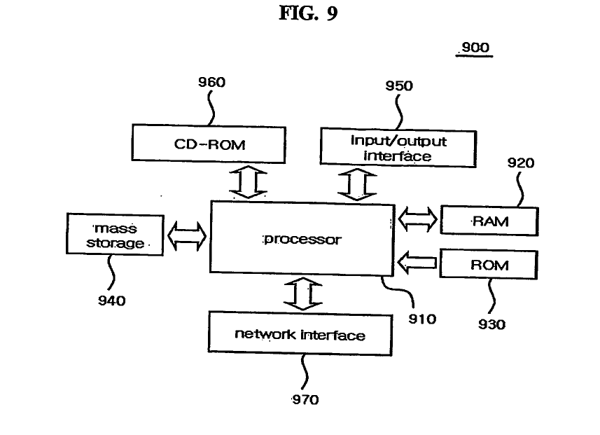

A method of processing the payment of bid fees according to an embodiment of the present invention is described with reference to FIG. 8 below. FIG. 8 is a flowchart showing an example of the method of processing the payment of bid fees according to the embodiment of the present invention.

The method of processing the payment of bid fees shown in FIG. 8 may be performed in conjunction with the step S330 of receiving bid request data from a bidder.

The auction service providing system 100 receives a user identifier or password required for user authentication from a bidder 160 at step S810. To perform the user authentication, user information including basic personal information associated with the bidder 160 should be recorded and maintained in the user information DB 180. The auction service providing system 100 receives basic personal information from the bidder 160 when the bidder 160 applies for membership, and the bidder 160 may change the basic personal information in case of need. The basic personal information may include the name, user identifier (user ID), password and phone number/mobile phone number of the bidder 160 that is required for user authentication. The basic personal information may further include information about mileage points or cyber coupons held by the bidder 160. The cyber coupons are modified cyber money used for the bidder 160 to participate in one bid. The value of a cyber coupon may be flexibly adjusted by an operator. The deposit of cyber coupons is accomplished by the bidder 160 purchasing cyber coupons. The auction service providing system 100 records the purchase of cyber coupons corresponding to the value of actual money in the storage area of the user information DB 180 associated with the bidder 160 in response to the coupon purchase request of the bidder 160. The actually money that can be used by the bidder 160 may be any means having value, such as cash, transfer, or a credit card.

Thereafter, the auction service providing system 100 authenticates the bidder 160 by comparing a user identifier or password with the bidder 160 with reference to the user information DB 180. Step S820 is the step of authenticating the bidder 160 when bid request data is created by the bidder 160 while the information of the bidder 160 is maintained in the commodity information DB 180. If the bidder 160 is not a member who has joined the auction service providing system 100, a process of applying for membership may be additionally performed.

Thereafter, the auction service providing system 100 transmits bid fee payment request data corresponding to bid request data received from the authenticated bidder 160 at step S830. Step S830 is the step of calculating the total number of bids made by the bidder 160 and requesting the payment of coupons corresponding to the calculated number of bids. For example, as shown in FIG. 4b, when the bidder 150 desires to make five bids in a multiple bid manner, five cyber coupons are required, and the auction service providing system 100 provides information about the requirement to the terminal 165 of the bidder 160.

Subsequently, the auction service providing system 100 provides a user interface for allowing the bidder 160 to input information about the payment of bid fees to the bidder 160 having performed a confirmation response to the bid fee payment request data at step 8840. Step S840 is the step of providing a certain user interface for receiving cyber coupons corresponding to the participation of the bidder 160 in an auction to the terminal 165. The bidder 160 becomes aware of the status of cyber coupons held by the user information DB 180 though the provided user interface.

Thereafter, the auction service providing system 100 receives information about the completion of bid fee payment from a certain payment system at step S850. Step S850 is the step of receiving cyber coupons from the bidder 160 or processing the purchase of cyber coupons through the user interface. For example, if cyber coupons corresponding to the number of bids is held by the storage area of the bidder 160, the auction service providing system 100 automatically subtracts the number of bids from the number of the held cyber coupons. In contrast, if the number of the held cyber coupons does not meet the number of bids, the auction service providing system 100 inquires the bidder 160 whether the bidder 160 has the intention of purchasing cyber coupons, and performs a process of allowing the bidder 160 to purchase the cyber coupons. The processing of the purchase of cyber coupons may be performed in a billing and payment system (not shown) included in the auction service providing system 100 of the present invention or an external billing and payment agent system. Purchased cyber coupons may be recorded in the user information DB 180 in the form of user information.

As a result the present invention can guarantee profits on the operation thereof by securely obtaining bid fees attributable to the bids of bidders, and can facilitate the procession of bid fee payment required for participation in auctions in appropriate conjunction with a payment system.

The present invention provides a computer-readable storage medium storing a compute program, which performs the various processes of the above-described embodiments of the present invention and which can be executed by a variety of computers. The computer-readable storage medium may include any combination of program instructions, data files and data structures. The program instructions may be instructions particularly designed and constructed for the present invention, or instructions known and available to those skilled in computer software. Examples of the computer-readable storage medium may includes a magnetic medium such as a hard disc, floppy disc or magnetic tape, an optical medium such as Compact is Disc-Read Only Memory (CD-ROM) or Digital Versatile Disc (DVD), a magneto-optical medium such as a floptical disc, and a hardware device particularly constructed to store and execute program instructions, such as ROM, Random Access Memory (RAM) or flash memory. The computer-readable storage medium may be a transmission medium including a carrier for transmitting signals indicating program instructions and data structures, such as an optical fiber, a metallic wire or a wave guide. Examples of a program instruction may be written not only in machine code through a compiler but also in high-level code capable of being executed by a computer using an interpreter.

FIG. 9 is a block diagram showing the internal configuration of a general purpose computer applicable to the auction service providing method and system of the present invention.

A computer 100 includes one or more processors connected to a main memory unit including RAM 920 and ROM 930. The processor 910 is called a Central Processing Unit (CPU). As well known in the art the ROM 930 functions to un-directionally transmit data and instructions to the CPU, and the RAM 920 functions to bi-directionally transmit data and instructions to the CPU. The RAM 920 and the ROM 930 may include appropriate configurations of the computer-readable storage medium. A mass storage 940 is bi-directionally connected to the processor 910 and provides an additionally data storage capacity. The mass storage 940 may be any of the above-described computer-readable storage media The mass storage 940 is used to a program and data, and is generally an auxiliary memory unit slower than the main memory unit, such as a hard disc. A specific mass storage such as CD-ROM is used in the computer 900. The processor 910 is connected to one or more input/output interfaces 950, such as a video monitor, a track ball, a mouse, a keyboard, a microphone, a touch screen type display, a card reader, a magnetic or paper tape reader, a voice or character recognition device, a joystick or some other known computer input/output device. The processor 910 may be connected to a wireless communication network. Through the connection with the communication network, the processor 910 performed the above-described processes. The above-described devices are well known to those skilled in computer hardware and software technology.

The above-described hardware apparatus may be constructed to be operated by one or more software modules for performing the method of the present invention.

As described above, the present invention provides an auction providing method and system, which determines successful bidders using a lowest bid price-based successful bid determination method of determining a smallest group of lowest bidders to be successful bidders, thus providing high-quality commodities to bidders at reasonable prices.

Furthermore, the present invention provides an auction providing method and system, which determines one or more lowest bidders to be successful bidders rather than a single highest bidder to be a successful bidder, thus preventing auctions from being unsuccessful and providing more opportunities for successful bids to bidders.

Furthermore, the present invention provides an auction providing method and system, which grants bid numbers to bidders according to the time when the bidders participate an auction and calculates the priorities of bidders having offered the same bid price based on the sequence of the bid numbers, thus reducing the influence of the sequence of participation on the determination of successful bidders and promoting the interests of bidders at the early stage of the auction.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of providing an auction service via the Internet, comprising the steps of:
maintaining a commodity information database (DB) for storing commodity information of a commodity for sale at auction;
maintaining a bid information DB for storing a bid table for registering bid request data regarding the commodity for sale at auction;
receiving bid request data including specific bid price information from bidders having searched the commodity information of the commodity for sale at auction;
registering the bid request data in bid registration fields of the bid table corresponding to the bid price information; and
determining one or more successful bidders according to predetermined criteria by analyzing the bid request data having been registered in the bid table after an elapse of a predetermined period;
wherein the predetermined criteria are based on the bid price information of the bid registration field and a number of items of the bid request data;
wherein the step of determining one or more successful bidders comprises the steps of:
calculating a number of items of the bid request data having been registered in the each of the bid registration fields, and selecting one or more bid registration fields having a smallest number of items of bid request data, and
selecting a bid request field having a lowest bid price among the selected bid registration fields, and determining one or more bidders having registered bid request data in the selected bid registration field to be successful bidders.

2. The method as set forth in claim 1, wherein:
the bid registration field includes a bid information item for registering bid number information created based on information of time when the bid request data is input;
the step of determining the bidders comprises the step of, if two or more bidders are determined to be successful bidders, comparing priorities of the bid request data that the successful bidders have registered, and determining a single bidder having a highest priority to be a final successful bidder; and
the priorities are calculated according to information about time when the bid request data are input, which is included in the bid number information.

3. The method as set forth in claim 1, wherein the commodity information registered in the commodity information DB further comprise bid price range information including an upper limit and a lower limit of the bid price information.

4. The method as set forth in claim 3, wherein:
the bid table includes one or more bid registration fields falling between the upper and lower limits of the bid price range information; and
the step of registering the bid request data comprises the step of sorting the bid registration fields in order of price magnitude.

5. The method as set forth in claim 1, further comprising the steps of:
maintaining a user information DB for storing one or more of a user identifier, a password, contact information and bid detail information of each of the bidder;
granting priority purchase rights for the commodity for sale at auction to the determined successful bidders, and recording information about the granted priority purchase rights in the user information DB;
transmitting the information about the granted priority purchase rights based on the contact information of the successful bidders with reference to the user information DB; and
providing user interfaces for receiving purchase form data to the successful bidders having made confirmation responses to the transmitted information about the granted priority purchase rights, the purchase form data including a payment method or a delivery address.

6. The method as set forth in claim 5, wherein the step of transmitting the information about the priority purchase rights comprises the steps of:
withdrawing the priority purchase rights granted to the successful bidders if conformation responses to the information about the priority purchase rights have not been received from the successful bidders, and recording information about the withdrawal of the priority purchase rights in the user information DB; and
re-determining one or more successful bidders according to a certain criteria by analyzing the bid request data registered in the bid table, except the bid request data input by the former successful bidders.

7. The method as set forth in claim 1, wherein the step of receiving the bid request data comprises the steps of:
receiving user identifiers or passwords required for user authentication from the bidders;
authenticate the bidders using the input user identifiers or passwords with reference to the user information DB;
transmitting bid fee payment request data corresponding to the received bid request data from the authenticated bidders;
providing user interfaces for allowing the bidders to input bid fee payment information to the bidders having made confirmation responses to the bid fee payment request data; and
receiving payment completion information corresponding to the input of the bid fee payment information.

8. A computer-readable storage medium storing a computer program for performing the method set forth in claim 1.

9. A system for providing an auction service via the Internet, comprising:
a commodity DB for storing commodity information of a commodity for sale at auction;
a bid information DB for storing a bid table for registering bid request data regarding the commodity for sale at auction;
interface means for receiving bid request data including specific bid price information from bidders having searched the commodity information of the commodity for sale at auction;
bid registration means for registering the bid request data in bid registration fields of the bid table corresponding to the bid price information; and
a successful bid control means for determining one or more successful bidders according to predetermined criteria by analyzing the bid request data registered in the bid table after an elapse of a predetermined period;
wherein the predetermined criteria are based on the bid price information of the bid registration field and numbers of items of the bid request data;
wherein the successful bid control means selects one or more bid registration fields having a smallest number of items of bid request data, selects a bid request field having a lowest bid price among the selected bid registration fields, and determines one or more bidders having registered bid request data in the selected bid registration field to be successful bidders.
